(19) United States
(12) Patent Application Publication
(10) Pub. No.: US 2024/0226725 A1
(43) Pub. Date: Jul. 11, 2024

(54) SYSTEMS AND METHODS FOR WIDE-BAND HAPTIC FEEDBACK

(71) Applicant: Dell Products L.P., Round Rock, TX (US)

(72) Inventors: Tyler Ryan Cox, Austin, TX (US); Jason Scott Morrison, Chadron, NE (US)

(73) Assignee: Dell Products L.P., Round Rock, TX (US)

(21) Appl. No.: 18/150,506

(22) Filed: Jan. 5, 2023

(51) Int. Cl. A63F 13/285; A63F 13/24; A63F 13/79

(52) U.S. Cl. CPC A63F 13/285; A63F 13/24; A63F 13/79

(57) ABSTRACT

An information handling system may determine one or more gaming context characteristics of a gaming application and may determine one or more haptic effects for generation by a linear magnetic ram module of an input device connected to the information handling system based on the one or more gaming context characteristics. The information handling system may transmit, to the input device, one or more instructions to generate the determined one or more haptic effects.

### FIELD OF THE DISCLOSURE

The instant disclosure relates to information handling systems. More specifically, portions of this disclosure relate to wide-band haptic feedback in an input device connected to an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A variety of input devices are available for use in providing user input to information handling systems. For example, popular input devices include keyboards, computer mice, handheld controllers, such as gamepads, and other input devices. To enhance immersion, particularly when executing gaming applications, input devices may include rumble modules, such as rumble modules including eccentric rotating mass (ERM) motors, to provide haptic feedback. The ability to provide haptic feedback using rumble modules including ERM motors may, however, be limited, as ERMs of the rumble modules may be fixed in frequency and may only be adjustable with respect to intensity.

Shortcomings mentioned here are only representative and are included simply to highlight that a need exists for improved information handling systems. Embodiments described herein address certain shortcomings but not necessarily each and every one described here or known in the art. Furthermore, embodiments described herein may present other benefits than, and be used in other applications than, those of the shortcomings described above.

### SUMMARY

An information handling system may determine one or more haptic effects for generation by a linear magnetic ram module of an input device connected to the information handling system based on one or more gaming context characteristics determined by the information handling system. For example, an input device of an information handling system, such as a handheld controller, may include one or more linear magnetic rams of a linear magnetic ram module for generation of haptic feedback. The linear magnetic ram module may be controlled to provide wide-band haptic feedback, allowing for generation of a wider variety of haptic feedback than other rumble modules, such as rumble modules including ERM motors. For example, the information handling system may control the linear magnetic ram module to generate one or more haptic effects, such as variable frequency haptic effects over a wide spectrum, variable intensity haptic effects over a wide spectrum, or tachammer mode chassis impacts which may not be possible when using ERM motors. Tachammer mode chassis impacts may, for example, include causing a magnet of the linear magnetic ram to impact a damping medium or impact plate at a high velocity to provide an intense haptic feedback event or jolt. Some gaming applications may not be configured to provide the wide range of haptic feedback that linear magnetic ram modules are capable of providing. Thus, an information handling system may, such as through a background service, determine one or more gaming context characteristics of a gaming application, such as an identity of a gaming application, a type of the gaming application, one or more events that occur in the gaming application, a user profile of a user playing the gaming application, or other gaming context characteristics and may determine haptic effects for generation by a linear magnetic ram module of an input device based on the gaming context characteristics. For example, an information handling system may determine that a user is driving a vehicle in a gaming application, taking damage in a gaming application, near an explosion or impact in a gaming application, or interacting with an object in a gaming application and may determine one or more haptic effects for generation by a linear magnetic ram module based on such a determination. Such functionality may enhance a user experience by providing wide-band haptic feedback, even when a user is playing gaming applications not programmed to provide such feedback, through detection of gaming context characteristics by the information handling system, such as by a background service of the information handling system separate and distinct from the gaming application.

An information handling system may determine one or more gaming context characteristics of a gaming application. Such gaming context characteristics may include a user profile of a user operating the information handling system, a game state of the gaming application, telemetry from the gaming application, an identity of the gaming application, or a genre of the gaming application. For example, a game state of the gaming application may include one or more events that have occurred in or are related to the gaming application, such as a user entering an aiming mode in a first person shooter, entering a specific area or level of the gaming application, moving a cursor or viewpoint of the gaming application to a particular area of a display of the information handling system, moving a two-axis input device a predetermined amount from a hold point, such as a starting or resting point, of the two-axis input device, other adjustments to the two-axis input device, equipping of a particular weapon in the gaming application, abilities or traits obtained in the gaming application, effects, such as status ailments, in the gaming application, a character state in the gaming application, a weapon/item state in the gaming application, cooldowns in the gaming application, terrain effects in the gaming application, a vehicle state in the gaming application, a user selection in the gaming application, one or more user attention vectors, attributes of in-game objects in the gaming application, and other game state information.

The information handling system may determine one or more haptic effects for generation by a linear magnetic ram module of an input device connected to the information handling system based on the one or more gaming context characteristics. Determining the one or more haptic effects may, for example, include determining one or more active haptic effects, such as one or more tachammer mode chassis impacts, or determining one or more haptic patterns, such as one or more rumble frequency or intensity patterns, such as frequency or intensity patterns associated with driving a vehicle or firing a weapon in game. The one or more haptic effects may be determined based on the one or more active effects and the one or more haptic patterns. The one or more haptic effects may comprise a raw waveform effect, such as a haptic effect generated based on audio, such as music, of a gaming application. The one or more haptic effects may comprise a haptic output effect, a haptic output rate, a haptic output frequency, and/or a haptic output intensity. The one or more haptic effects may comprise a harmonic haptic effect for a plurality of motors of the linear magnetic ram module. For example, the linear magnetic ram module may be comprised of two, or more, linear magnetic rams, such as linear magnetic rams in right and left grips of a handheld controller. The one or more haptic effects may include harmonic frequency haptic effects for generation by two or more linear magnetic rams of the linear magnetic ram module of the input device. The one or more haptic effects may comprise an adjustment to a tunable damping medium of the linear magnetic ram module. Thus, a variety of haptic effects may be determined based on one or more determined gaming context characteristics.

The information handling system may then transmit to the input device, such as to the handheld controller, one or more instructions to generate the determined one or more haptic effects. The input device may then generate, by the linear magnetic ram module, the one or more haptic effects.

In some embodiments, an information handling system may include a memory and a processor for performing the methods described herein. A computer program product may include a non-transitory computer-readable medium including instructions for causing an information handling system to perform the method described herein.

For example, the methods described herein may be embedded in a computer-readable medium as computer program code comprising instructions that cause a processor to perform operations corresponding to the steps of the method. In some embodiments, the processor may be part of an information handling system including a first network adaptor configured to transmit data over a first network connection; and a processor coupled to the first network adaptor, and the memory.

In some embodiments, the aspects described herein may be used to support the execution of gaming applications in different environments. Gaming sessions may execute on a service, either locally on a device, on another system on the network, or in the cloud. A device may access the gaming session by executing an application that communicates with the service to receive and transmit user input to the service and provide feedback to the user from the service. The device may include its own audio/visual (AV) output for displaying a graphical user interface and/or a rendered display from the gaming session. Different environments at a location may include different AV systems, and the device may be automatically paired with an AV system and may be reconfigured to support interaction with an application session using the paired AV system.

A user's home is one example location that may have multiple environments, such as a living room, a dining room, a study, and/or a bedroom, each with different screen configurations, speaker configurations, and/or network availability. Aspects of embodiments disclosed herein may provide a system that enables game play from a set of candidate game hosts and environments to consumption devices of a user's choice while the user moves about their home between the different environments. The system may employ methods to determine where a user is located within the home, availability and selection of candidate game hosting and target environments, homing and direction of related I/O, and/or AV for consumption. The system then migrates the user and their information to the determined environment by coordinating gameplay by the user. The solution accommodates multiple users simultaneously within the home, whether in single player, multiplayer using the same screen, or multiplayer using separate screen games. The solution may configure AV and input/output (I/O) such that multiple users can consume one or multiple games in the home simultaneously, whether in separate locations or when seated together in front of the same consumption device, e.g., a large television, where multiple games might be hosted simultaneously.

The mobility of a user between services and applications for executing an application session may be supported by an information handling system that uses available telemetry from multiple sources to build a confidence-based knowledge graph of the user's gaming environments and determine a position of the user within that graph. A system with knowledge of devices in a user's gaming environment may build a knowledge graph by aggregating and comparing telemetry. For example, network telemetry may reveal that devices are positioned relatively near each other, a mobile device may reveal an absolute location based on GPS data, and/or an infrared presence sensor may reveal that the user is sitting in front a device. An intelligent system may assemble these individual pieces of telemetry into a broader knowledge graph based on the absolute and/or relative locations of the user's devices, the location of the user in relation, and or characteristics of the devices. This knowledge graph may be updated in real time and/or based on changes in device telemetry.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art. As used herein, “pressing” may refer to touching of a surface or applying pressure to a surface of a device, such as a touchpad.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating aspects of a configurable system for providing services to users according to some embodiments of the disclosure.

FIG. 2 is a block diagram illustrating possible game environments according to some embodiments of the disclosure.

FIG. 3A is a block diagram illustrating application and services hosted in different gaming environments according to some embodiments of the disclosure.

FIG. 3B is a block diagram illustrating application and services hosted in different gaming environments according to some embodiments of the disclosure.

FIG. 3C is a block diagram illustrating application and service hosted in a common gaming environment according to some embodiments of the disclosure.

FIG. 3D is a block diagram illustrating a cloud-based service arrangement for a gaming environment according to some embodiments of the disclosure.

FIG. 4 is a perspective view of an example handheld controller according to some embodiments of the disclosure.

FIG. 5 is a block diagram of an example system for generation of wide-band haptic feedback according to some embodiments of the disclosure.

FIG. 6 is a block diagram of an example system for generation of wide-band haptic feedback according to some embodiments of the disclosure.

FIG. 7 is a flow chart of an example method for generation of wide-band haptic feedback according to some embodiments of the disclosure.

FIG. 8 is a block diagram of an example information handling system according to some embodiments of the disclosure.

FIG. 9 is a perspective view of an example linear magnetic ram according to some embodiments of the disclosure.

FIG. 10 is a block diagram of a linear magnetic ram having an adjustable damping medium according to some embodiments of the disclosure.

### DETAILED DESCRIPTION

These example embodiments describe and illustrate various aspects of a configurable and dynamic gaming environment that can be supported through the use of a hub device, which may be an information handling system. A hub device may be located in a user's home and used to arrange game play sessions (or more generically application sessions) between host devices and services. The host devices may execute an application for receiving an AV stream for displaying rendered content from a game play session (or other application session), and in some configurations also receive user input for interacting with the session from a peripheral device, such as a gaming controller. The AV stream presented by the host device may be generated by a service. The service may execute on the hub device or another information handling system, such as a cloud computing resource. A home may include one or several host devices (e.g., televisions, mobile computers, tablet computers, and personal computers) and may include one or several information handling systems executing the service (e.g., a hub devices and personal computers).

The user's home may be divided into different environments defined by a space around a host device. For example, a living room with a television may be one environment and a bedroom with a personal computer may be another environment. A user may use a peripheral device in one of the environments and the hub device may configure a host device, a service, and the peripheral device for operation in the environment by determining the corresponding environment using a knowledge graph. The knowledge graph provides a database of historical information about the environments from which the hub device may use current characteristics of the peripheral device to deduce the location, and thus current environment, of the peripheral device. For example, the knowledge graph may include information about location of rooms (e.g., environments) in the house based on wireless signatures of devices within the different rooms. This difference in signatures reflects that a device on a one side of the house may receive beacon signals from different neighboring access points than a device on an opposite side of the house. When a user carries the peripheral device around the house, the hub device may determine a location of the peripheral device based on visible access points to the peripheral device. Other example characteristics beyond wireless signature for determining location are described in further detail below, and the knowledge graph may be used to combine different characteristics to identify the location, and thus environment, of the peripheral device.

Based on the location of the peripheral device determined from the knowledge graph, the hub device may initialize an application session for the peripheral device by determining an appropriate host device and service for the application session. For example, if the peripheral device is in the living room and is requesting a game that is within the capabilities of the service on the hub device to execute, the hub device may initialize an application session for the peripheral device between the television as a consumption device and the hub device as a service. The service on the hub device executes the game and streams rendered content to an application executing on the television consumption device.

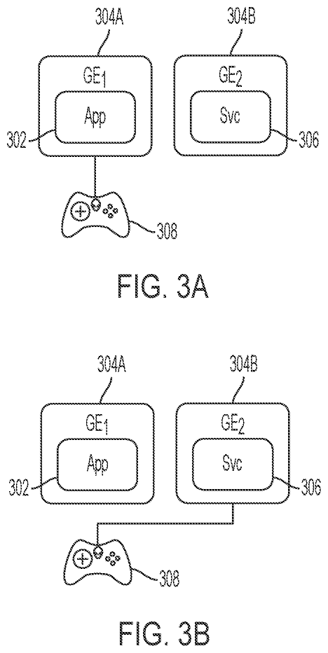

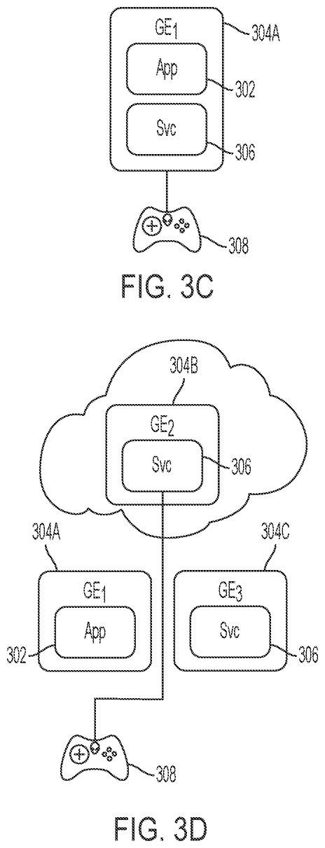

The hub device may be used to migrate the peripheral device to a different environment and/or migrate the application session between host devices and/or services. For example, initially the application session may use a communication link between the peripheral device and the television host device for receiving user input, in which the application executing on the television host device relays user input to the service through a backhaul communication link from the television host device to the hub device. During the application session, the hub device may monitor characteristics of the peripheral device, including signal strength of connection to other components, and determine that the communication link from the peripheral device to the hub device is stronger than the peripheral device to the television host device. The hub device may migrate the peripheral device to a communications link with the hub device such that the service executing on the hub device directly receives the user input but the streaming session continues from the service to the application executing on the television host device. Such a change is illustrated in the change in configuration from FIG. 3A to the configuration of FIG. 3B described in further detail below.

Other aspects of the application session may also be migrated. For example, if the peripheral device is determined to move to a different environment, then the hub device may migrate the application session to an application executing on a host device within the new environment. As another example, if a connection between the television host device and the service becomes unstable, the hub device may recommend and/or initiate a migration of the application session to a different host device. One scenario for such a migration may be where the television host device is connected through a wireless link to the service in which the wireless link quality is reducing quality of the streaming and a second host device with a wired connection is available in a nearby environment. Each of these example migrations may be determined based on information in the knowledge graph regarding locations of environments and capabilities within those environments. As yet another example, a user may request execution of an application, such as a particular game, during the application session for which a better configuration exists than the current host device and/or current service. The request for a different application, such as a game requiring a certain GPU capability, may cause the hub device to determine that a second device executing a second service is better for hosting the application and migrate the peripheral device to the second service by, for example, reconfiguring network connections.

The hub device may support connecting to multiple peripheral devices. In one example, the hub device may support two peripheral devices using a shared session on one host device to play the same or different games on the host device. In another example, the hub device may support two peripheral devices in different environments using different sessions with different host devices. The hub device may determine the environment of each of the peripheral devices based on characteristics of the device and the knowledge graph and configure application session for each of the peripheral devices accordingly. Different arrangements of peripherals and players may be supported. For example, one hub device executing a service and one host device executing an application can support a configuration with Game A and one player (P1) with peripheral (C1) and Game B and one player (P2) with peripheral (C2); or can support a configuration with Game A and one player (P1) with peripheral (C1) and Game A and one player (P2) with peripheral (C2); or can support a configuration with Game A and two players (P1, P2) with peripherals (C1, C2).

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

FIG. 1 is a block diagram illustrating aspects of a configurable system for providing services to users according some embodiments of the disclosure. A system 100 includes users 102 who may have access to a shared library of applications 106 including applications 108A-108N. The users 102 may have separate libraries, with some overlapping applications between the libraries. The users 102 may access the library 106 through devices 110A-I, such as mobile gaming device 110A, tablet computing device 110B, phone computing device 110C, television 110D, personal computing device 110E, desktop computing device 110F, laptop computing device 110G, game controller 110H, VR headset 1101. The devices 110 may access services at any of locations 112, including cars, busses, homes, hotels, offices, parks, etc. One or more of the devices 110 may communicate with an application session executing on a computing device 114, such as a home application hub 114A, a server 114B, or a cloud execution environment 114C. In some embodiments, environments may only exist for fixed devices, e.g., desktop computers, televisions, etc.

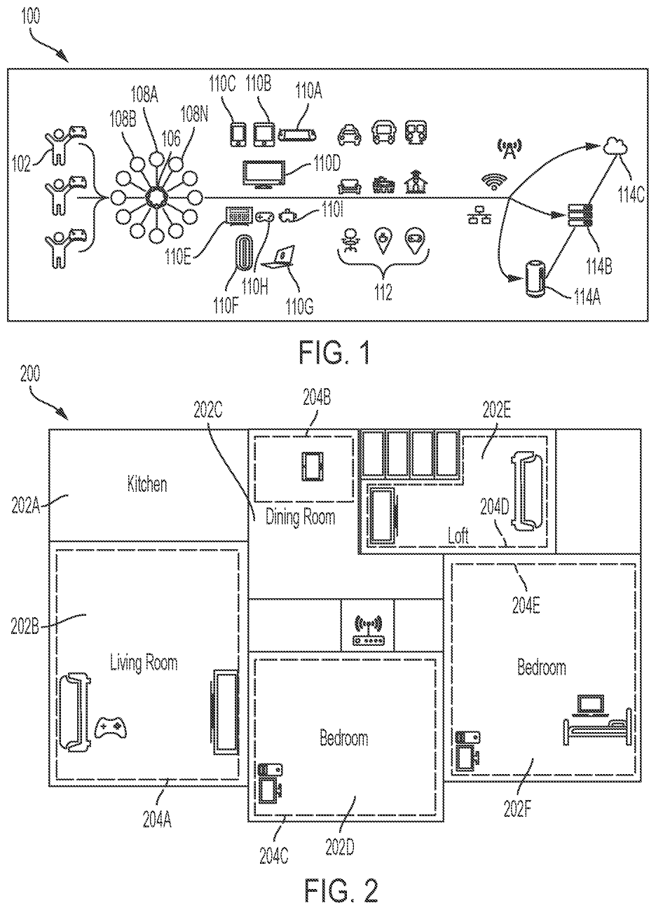

FIG. 2 is a block diagram illustrating possible game environments according to some embodiments of the disclosure. A user's home 200 may include rooms 202A-F, and each of the rooms may have different information handling systems present, different AV equipment present, and/or different characteristics. For example, a living room 202B may include a large-size television, a bedroom 202D may include a personal computer, and a dining room 202C may include a table computing device. Gaming environments 204A-E in the home 200 may be defined based on spaces where a user is likely to execute an application session. Each gaming environment 204A-E may include numerous devices and gaming environments, devices that may or may not be capable of hosting games, and/or devices that may or may not be capable of receiving game output. A system 100 may allow multiple users in the home 200 to simultaneously execute an application session. In some embodiments, multiple games may be hosted on a single device. In some embodiments, multiple games may target a single output device. In some embodiments, solution manages where games should be hosted, where game output should go, and how to best route peripheral I/O for users.

A user may move between gaming environments 204A-E within the home 200 and continue an application session. For example, a user may take a device, such as a gaming controller, from environment 204A to environment 204C. The gaming controller may migrate and reconfigure for operation in environment 204C from a configuration for environment 204A. For example, the controller may transition from an application hosted on a TV in living room 202B to an application hosted on TV in dining room 202C while remaining connected to a host service executing on a PC in bedroom 202D.

Example configurations for applications and services in gaming environments are shown in FIGS. 3A-3D. FIG. 3A is a block diagram illustrating application and services hosted in different gaming environments according to some embodiments of the disclosure. In FIG. 3A, a first gaming environment 304A may include a device, such as a TV or PC, hosting an application 302, which is an endpoint for an application session such as a gaming session. The application 302 communicates with a service 306, which may be hosted on a device in a different gaming environment 304B. A controller 308 may communicate with the application 302 to receive user input for the application session to control, for example, a character in a game. In some embodiments, the controller 308 is connected to the environment 304A hosting the application and the I/O is configured to be relayed to the environment 304B hosting the actual game.

Another arrangement for the application and service is shown in FIG. 3B. FIG. 3B is a block diagram illustrating application and services hosted in different gaming environments according to some embodiments of the disclosure. In FIG. 3B, the controller 308 communicates with the service 306 for providing user input to an application session, with the AV rendering target of the application session being application 302 in a different gaming environment.

Another arrangement for the application and service is shown in FIG. 3C. FIG. 3C is a block diagram illustrating application and service hosted in a common gaming environment according to some embodiments of the disclosure. In FIG. 3C, the application 302 and the service 306 are executed in the same gaming environment 304A, which may be a single device, two devices, or a combination of devices in the gaming environment 304A. The controller 308 may communicate with either the service 306 and/or the application 302.

A further arrangement for the application and service is shown in FIG. 3D. FIG. 3D is a block diagram illustrating a cloud-based service arrangement for a gaming environment according to some embodiments of the disclosure. In FIG. 3D, the controller 308 may communicate with a service 306 hosted in a gaming environment 304B that is remote from the gaming environment 304A in which the application 302 is executing. The service 306 may be executing, for example, on a remote device, such as when the user's home includes the gaming environment 304B but the user is engaging with application 302 at a location on a different network from their home (e.g., at a friend's house). The service 306 may also or alternatively be executed, for example, on a cloud computing device available as a subscription service to the user.

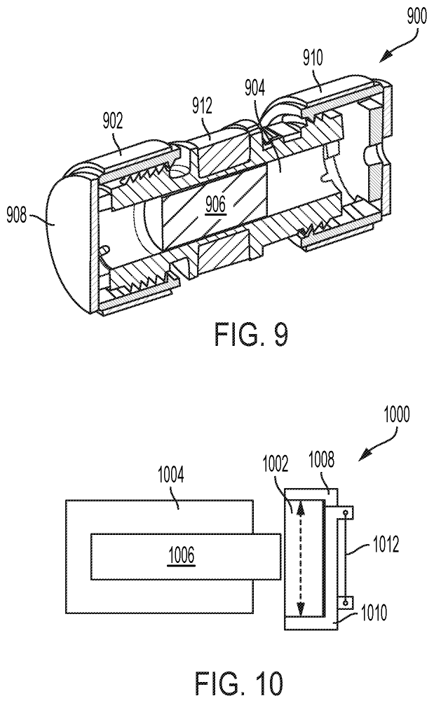

An information handling system may be connected to an input device, such as a handheld controller, mouse, or other input device, capable of generating wide-band haptic feedback, such as haptic feedback at a wide range of frequencies and/or intensities. For example, an input device may include a linear magnetic ram module including one or more linear magnetic rams for generating haptic feedback. Linear magnetic rams may generate haptic feedback based on movement of a magnet housed inside the linear magnetic ram in response to variation of an electromagnetic field about the magnet that causes the magnet to move along a linear path. A perspective view of an example linear magnetic ram 900 for generating haptic feedback is shown in FIG. 9. The linear magnetic ram 900 may include a housing 902 having a channel 904 for linear movement of a hammer 906 to impact a damping medium 908. A motor module 910 may generate a magnetic field to move the hammer 906 within the channel 904 to impact the damping medium 908. For example, the motor 910 may cause magnet 912 to generate a magnetic field to move the hammer 906 to impact the damping medium 908. The hammer 906 may, for example, be made of a magnetic or metallic substance responsive to a magnetic field generated by magnet 912. A tension on the damping medium 908 may be adjustable to produce different haptic effects when the hammer 906 impacts the damping medium 908. In some embodiments, the linear magnetic ram 900 may be controlled to cause the hammer 906 to impact the damping medium 908 and/or to adjust the tension on the damping medium 908 based on events that occur in a gaming application or based on a user profile of a user of the information handling system, such as based on gaming context characteristics.

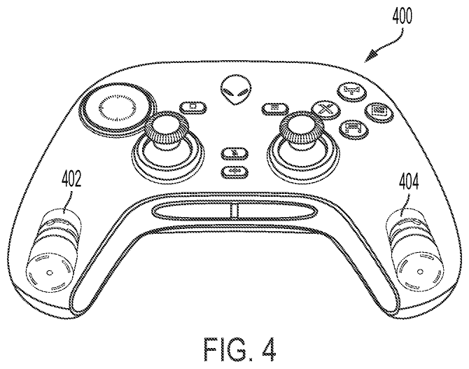

A handheld controller 400, shown in FIG. 4, is one example of an input device that may include a linear magnetic ram module for generation of wide-band haptic feedback. The handheld controller 400 may include a first linear magnetic ram 402 and a second linear magnetic ram 404 for generating haptic feedback, and the first linear magnetic ram 402 and the second linear magnetic ram 404 may be included in a linear magnetic ram module. In some embodiments, the linear magnetic rams 402, 404 may be included in respective left and right hand grips of a handheld controller 400. In some embodiments, a handheld controller 400 may include fewer or greater than two linear magnetic rams. In some embodiments, linear magnetic rams may be included in other input devices for generation of haptic feedback, such as computer mice, wearable devices, or other input devices.

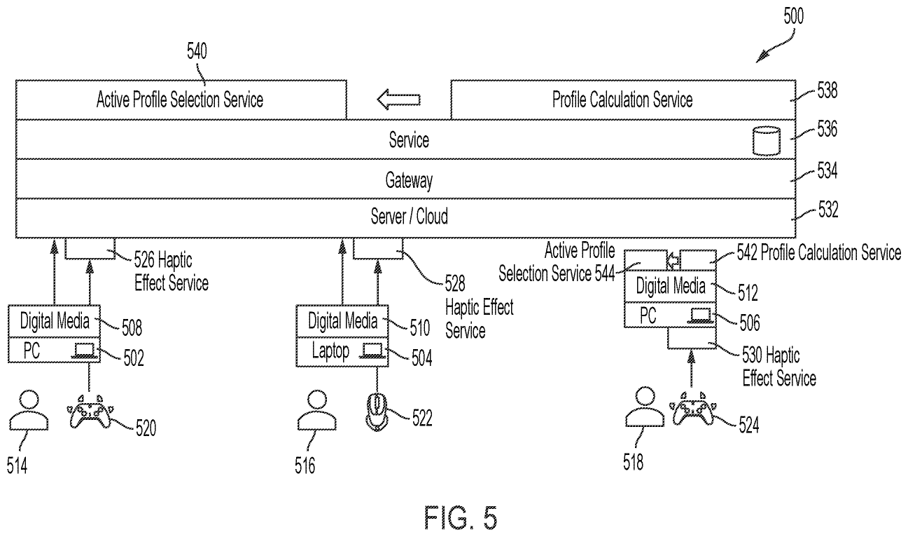

An information handling system to which an input device with wide-band haptic feedback capabilities is connected may instruct the handheld controller to provide wide-band haptic feedback effects based on one or more determined gaming context characteristics, such as based on a user profile of a user of the information handling system, based on a game state of the gaming application, or based on other gaming context characteristics. A game state of the gaming application may include gaming context characteristics such as one or more events that have occurred in or related to the gaming application. For example, a game state may include a user entering an aiming mode in a first person shooter, entering a specific area or level of the gaming application, moving a cursor or viewpoint of the gaming application to a particular area of a display of the information handling system, moving a two-axis input device a predetermined amount from a hold point, such as a starting or resting point, of the two-axis input device, other adjustments to the two-axis input device, equipping of a particular weapon in the gaming application, abilities or traits obtained in the gaming application, effects, such as status ailments, in the gaming application, a character state in the gaming application, a weapon/item state in the gaming application, cooldowns in the gaming application, terrain effects in the gaming application, a vehicle state in the gaming application, a user selection in the gaming application, one or more user attention vectors, attributes of in-game objects in the gaming application, and other game state information. An example system 500 for generation of wide-band haptic feedback is shown in FIG. 5.

As shown in FIG. 5, a first user 514 may use a first input device 520, such as a handheld controller, for providing input to a first information handling system 502, such as a desktop personal computer, that is executing a first digital media application 508, such as a first gaming application. A second user 516 may use a second input device 522, such as a computer mouse, to provide input to a second information handling system 504, such as a laptop computer, that is executing a second digital media application 510, such as a second gaming application. A third user 518 may use a third input device 524, such as a handheld controller, to provide input to a third information handling system 506, such as a desktop personal computer, that is executing a third digital media application 512, such as a third gaming application. The first input device 520, the second input device 522, and the third input device 524 may each include linear magnetic ram modules for generation of wide-band haptic feedback.

In some embodiments, a service for determining gaming context characteristics and haptic effects based on determined gaming context characteristics may be executed locally on an information handling system executing a gaming application for which haptic effects are being determined and generated, while in other embodiments such a service may be executed partially or entirely in the cloud. For example, the third information handling system 506 may execute a haptic effect service 530, a profile calculation service 542, and a profile selection service 544 locally to determine one or more haptic effects. In particular, the third information handling system 506 may determine, by a profile calculation service 542, one or more gaming context characteristics for the digital media application 512, such as a user profile of user 518 or one or more game states of the digital media application 512. The gaming context characteristics may be provided to a locally executed active profile selection service 544 that may determine an active haptic feedback profile for the input device 524 based on the one or more gaming context characteristics. In some embodiments, the profile calculation service 542 may generate one or more haptic feedback profiles that correspond to one or more gaming context characteristics, and the active profile selection service may select a haptic feedback profile from among the generated profiles based on one or more gaming context characteristics for the digital media application 512. The haptic effect service 530, which may also be executed locally on the information handling system 506, may receive the determined active haptic feedback profile from the active profile selection service 544 and may determine one or more active effects and/or one or more haptic patterns based on the active haptic feedback profile and the gaming context characteristics. The haptic effect service 530 may then instruct the input device 524 to generate the determined active effects and/or haptic patterns.

In some embodiments, part, or all, of a service for determining gaming context characteristics and haptic effects based on determined gaming context characteristics may be executed in the cloud, such as by one or more remote information handling systems. Such operation will be discussed with respect to information handling system 502 but may also apply to information handling system 504 or other information handling systems. Information handling system 502 may communicate with a server/cloud-based system 532. The server or cloud-based system 532 may communicate with a gateway 534, which may, in turn, communicate with a service 536, such as a gaming service, for gaming context characteristic collection. In some embodiments, the service 536 may include or may be included in the service 306. The service 536 may communicate with or may include a profile calculation service 538 and an active profile selection service 540. Thus, information, such as gaming context characteristics or gaming data upon which gaming context characteristics are determined may be transmitted from the information handling system 502 to the server or cloud-based system 536, from the server or cloud-based system 532 to the gateway 534, from the gateway 534 to the service 536, and from the service 536 to the profile calculation service 538 and/or the active profile selection service 540. A determined active profile may be transmitted from the active profile selection service 540 may determine an active haptic feedback profile and may transmit the active feedback profile to the haptic effect service 526 through the service 536, the gateway 534, and the server or cloud-based system 532. In particular, the first information handling system 502 may determine one or more gaming context characteristics for a digital media application 508 executed by the first information handling system 502. The information handling system 502 may transmit the gaming context characteristics to service 536 by way of gateway 534 and server or cloud-based system 532. In some embodiments, the information handling system 502 may transmit gaming data to service 536 and service 536 or profile calculation service 538 may determine gaming context characteristics based on received gaming data. In some embodiments, the profile calculation service 538 may generate multiple haptic profiles for multiple different gaming contexts for use by active profile selection service 540. The gaming context characteristics may, in some embodiments, be provided to an active profile selection service 540 which may determine an active haptic feedback profile for the input device 520 based on the one or more gaming context characteristics. For example, the active profile selection service 540 may select an active haptic profile from a plurality of potential haptic profiles generated by profile calculation service 538. The haptic effect service 526 may receive the determined active haptic feedback profile from the active profile selection service 544 and may determine one or more active effects and/or one or more haptic patterns based on the active haptic feedback profile and/or the gaming context characteristics. In some embodiments, the haptic effect service 526 may receive one or more gaming context characteristics from the information handling system 502. The haptic effect service 526 may then instruct the input device 520 to generate the determined active effects and/or haptic patterns. For example, the haptic effect service 526 may transmit instructions to the first information handling system 502 for generation of the determined active effects and/or haptic patterns, and the first information handling system 502 may pass the instructions to the input device 520. Thus, a background service operated either in the cloud or on an information handling system may determine gaming context characteristics for a digital media application, such as a gaming application, executed by an information handling system and may determine one or more haptic effects for generation by an input device based on the one or more gaming context characteristics. Such generation may allow for utilization of wide-band haptic feedback capabilities of an input device even if the digital media application is not programmed to utilize wide-band haptic feedback capabilities, such as linear magnetic ram haptic feedback capabilities, of the input device.

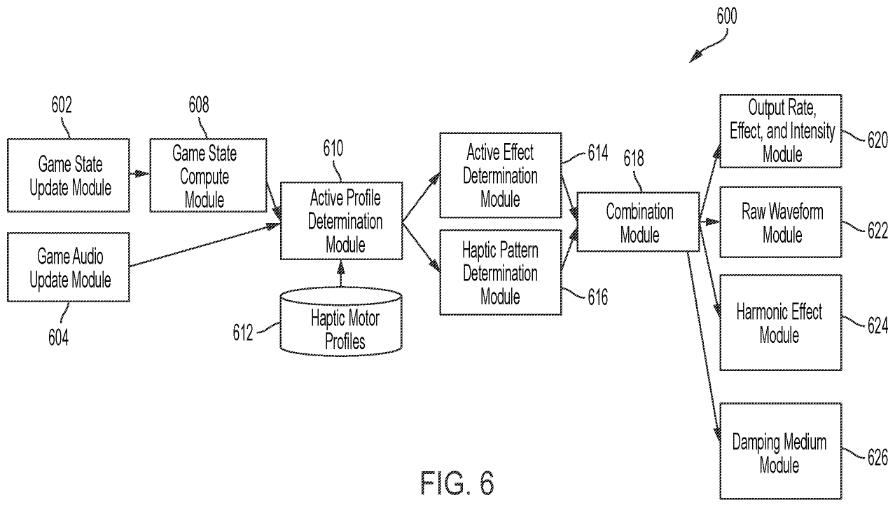

An example block diagram of a system 600 for generation of wide-band haptic feedback is shown in FIG. 6. Such a system may be executed by an information handling system executing a gaming application, by a cloud-based information handling system connected to an information handling system executing a gaming application, or by another information handling system. Game state update module 602 may determine when a game state for a gaming application has been updated. For example, game state update module 602 may monitor a gaming application executed by an information handling system to determine when one or more gaming context characteristics, such as a user playing a gaming application or one or more aspects of a gaming application, have changed. Game state compute module 608 may determine one or more gaming context characteristics of a gaming application, such as one or more game states of a gaming application. For example, an information handling system may monitor a gaming application executed by the information handling system or by another information handling system, such as monitoring video content, user input, audio content, or other information of the gaming application, to detect game state information, such as game events, as described in U.S. Pat. No. 11,141,658 to Cox et al. and entitled “GAMEPLAY EVENT DETECTION AND GAMEPLAY ENHANCEMENT OPERATIONS,” which is hereby incorporated by reference. Such monitoring and analysis may be performed by the information handling system executing the gaming application or by a remote information handling system in the cloud, such as a cloud-based server. For example, in some embodiments, the information handling system executing the gaming application will transmit data related to the gaming application to the cloud for analysis, and may receive information regarding game state information, such as game events, and/or information regarding adjustments that should be made to a resistance of a two-axis input device connected to the information handling system based on determined game state information, such as game events. Game state information may is one example of gaming context characteristics, as discussed herein. In some embodiments, game state compute module 608 may determine other gaming context characteristics, such as a user profile of a user playing the gaming application.

Active profile determination module 610 may determine an active haptic profile for an input device connected to the information handling system executing the gaming application based, at least in part, on the one or more gaming context characteristics. For example, in some embodiments, an information handling system may store a plurality of haptic motor profiles 612 corresponding to one or more gaming context characteristics or sets of gaming context characteristics. In some embodiments, a user may manually configure one or more haptic motor profiles according to certain game states, such as specific haptic motor profiles for specific gaming applications, and a haptic motor profile from among the manually configured haptic motor profiles may be selected based on gaming context characteristics indicating a profile of the user. In some embodiments, game audio update module 604 may provide gaming context characteristics, such as game audio information or music audio information, to active profile determination module 610. Active profile determination module 610 may, for example, determine a profile based on such audio information in place of or in addition to one or more game states determined by game state compute module 608.

The active effect determination module 614 may determine one or more active effects based on an active profile determined by active profile determination module 610, one or more gaming context characteristics, such as one or more game states, determined by game state compute module 608, and/or audio characteristics, which may be another example of gaming context characteristics, determined by game audio update module 604. Active effects may, for example, include responses to actions that occur in a game such as firing a weapon in-game, jumping in-game, taking damage in-game, making impacts or explosions in-game, crashing a car in-game, picking up or interacting with an object in-game, or other in-game events. For example, determination of such active effects may result in instructing an input device to generate tachammer mode chassis impacts using a linear magnetic ram module.

Likewise, haptic pattern determination module 616 may determine one or more haptic patterns based on an active profile determined by active profile module 610, one or more gaming context characteristics, such as one or more game states, determined by game state compute module 608, and/or audio characteristics, which may be another example of gaming context characteristics, determined by game audio update module 604. Haptic patterns may, for example, include rumble or other haptic patterns for generation based on driving a vehicle in-game, firing a weapon in-game, in-game background music or audio, external music or audio, picking up or interacting with an object in-game, or other in-game effects. Haptic patterns may differ from active effects in that active effects may include haptic feedback generated in response to specific in-game events, while haptic patterns may be generated in response to statuses, continuous in-game states, or other haptic feedback events that extend for at least a predetermined period of time.

In some embodiments, active effect determination module 614 and haptic pattern determination module 616 may receive haptic feedback instructions from a gaming application, such as legacy haptic feedback instructions for an ERM or other haptic feedback module, and may generate haptic feedback instructions for a linear magnetic ram module of an input device to generate haptic feedback that corresponds to the legacy haptic feedback. Thus, the information handling system may emulate the legacy haptic feedback using the linear magnetic ram haptic feedback module.

The active effect determination module 614 and the haptic pattern determination module 616 may pass determined active effects and haptic patterns to combination module 618, which may generate instructions for a linear magnetic ram module of an input device, such as a handheld controller, based on the active effects and haptic patterns. Thus, the combination module 618 may generate instructions for a linear magnetic ram module of an input device based on the haptic patterns and/or active effects.

The combination module 618 may include modules for generating specific kinds of haptic feedback active effects and/or patterns. For example, an output rate, effect, and intensity module 620 may determine a haptic output rate, such as an output frequency, a haptic output effect, such as a tachammer mode chassis impact, or a haptic output intensity, such as a velocity with which a magnet is caused to collide with a damping medium, of a linear magnetic ram module. As one particular example, the output rate, effect, and intensity module 620 may generate instructions for haptic effect playback with variable rates an intensity. As another example, a tachammer mode chassis impact may provide maximum haptic feedback intensity and may be synchronized with audio to provide additional feedback. In some embodiments, the output rate, effect, and intensity module 620 may determine one or more frequency patterns, intensity patterns, or output effect patterns to be generated by a linear magnetic ram module of an input device. Thus, the output rate, effect, and intensity module 620 may generate instructions regarding an output rate, effect, and intensity and may transmit such instructions to an input device including a linear magnetic ram module. Such instructions may be generated based on one or more active effects determined by active effect determination module 614 and/or one or more haptic patterns determined by haptic pattern determination module 616.

Raw waveform module 622 may determine a haptic effects that correspond to a raw audio waveform, such as an audio waveform for in game audio or external audio. For example, raw waveform module 622 may include a waveform driver to translate in-game or external audio into synthetic haptic effects. Thus, the raw waveform module 622 may generate instructions for an input device to generate haptic feedback that corresponds to in-game or external audio and may transmit such instructions to the input device. Such instructions may be generated based on one or more active effects determined by active effect determination module 614 and/or one or more haptic patterns determined by haptic pattern determination module 616.

Harmonic effect module 624 may determine haptic effects that correspond to one or more gaming context characteristics. For example, the harmonic effect module 624 may determine instructions for multiple linear magnetic rams of a linear magnetic ram module of an input device to generate harmonic haptic effects through frequency and/or intensity of operation of the linear magnetic rams, such as through phase-aligned multi-motor effects. The harmonic effect module 624 may thus generate instructions for a linear magnetic ram module of an input device to generate harmonic haptic effects using a plurality of linear magnetic rams of the linear magnetic ram module, and may transmit instructions for generation of such haptic effects to the input device. Such instructions may be generated based on one or more active effects determined by active effect determination module 614 and/or one or more haptic patterns determined by haptic pattern determination module 616.

Damping medium module 626 may determine one or more adjustments to a damping medium of one or more linear magnetic rams of a linear magnetic ram of a handheld controller. For example, a tension on a damping medium of a linear magnetic ram may be adjusted based on one or more gaming context characteristics. For example, adjustments to a tension on a damping medium of a linear magnetic ram may be determined based on one or more gaming context characteristics. The damping medium module 626 may generate instructions for an input device to perform adjustments to a damping medium and may transmit such instructions to the input device. Such instructions may be generated based on one or more active effects determined by active effect determination module 614 and/or one or more haptic patterns determined by haptic pattern determination module 616.

As one particular example one or more adjustments to a tension of a damping medium may be determined by damping medium module 626 of FIG. 6. A block diagram of an example haptic damping module 1000 with a damping medium 1002 having an adjustable tension is shown in FIG. 10. A haptic engine 1004, which may include a motor, and a magnet as described with respect to FIG. 5, may drive a hammer 1006 into the damping medium 1002. The damping medium 1002 may, for example, be made from a polymer or other flexible or semi-flexible material. The damping medium 1002 may be attached, at a first end, to a first arm member 1008 and at a second end, opposite the first end, to a second arm member 1010. The first arm member 1008 and the second arm member 1010 may be used to adjust a tension on the damping medium 1002. For example the first arm member 1008 may be moved in a first direction, such as up, and/or the second arm member may be moved in a second direction, such as down, to increase a tension on the damping medium 1002. In some embodiments, the first arm member 1008 and the second arm member 1010 may be made of a polymer, a metal, or another substance. The first arm member 1008 and the second arm member 1010 may be connected to a shape memory alloy actuator 1012. The shape memory alloy actuator 1012 may be formed from a shape memory alloy that assumes a first shape when an electric charge is applied and a second shape when the electric charge is not applied. In some embodiments, the shape memory alloy actuator 1012 may include one or more shape memory alloy wires. Such wires may have a fast response time to an electric charge and may operate at a low electric charge. For example, when an electric charge is applied to the shape memory alloy actuator 1012, the shape memory alloy actuator may expand. Such expansion may push the first arm member 1008 upward and the second arm member 1010 downward, stretching the damping medium attached to the first and second arm members 1008, 1010. When then charge is removed, the shape memory alloy actuator 1012 may contract, returning the arm members 1008, 1010 and damping medium 1002 to an initial position. In some embodiments, different charges may cause the shape memory alloy actuator 1012 to assume different shapes, such as different lengths, allowing varying degrees of tension to be applied to the damping medium 1002. In some embodiments, multiple arm members may be attached to different shape memory alloy actuators. For example, a first set of arm members may be adjusted by a first shape memory alloy actuator to stretch the damping medium 1002 along a first axis, and a second set of arm members may be adjusted by a second shape memory alloy actuator to stretch the damping medium 1002 along a second axis.

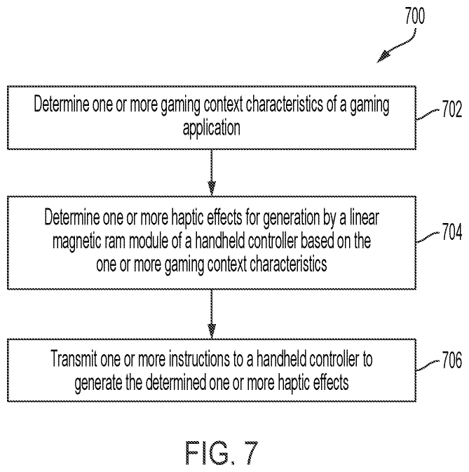

An example method for generation of wide-band haptic feedback with a linear magnetic ram module is shown in FIG. 7. The method 700 may begin at block 702 with determining one or more gaming context characteristics of a gaming application. For example, an information handling system executing a gaming application may determine one or more gaming context characteristics of a gaming application. Alternatively or additionally, an external information handling system, such as a cloud-based information handling system, may receive gaming data from an information handling system executing a gaming application and may determine one or more gaming context characteristics based on the gaming data. As another example, an external information handling system, such as a cloud-based information handling system, may receive gaming context characteristics from an information handling system executing a gaming application. In some embodiments, a service executed by the information handling system executing the gaming application or another information handling system may monitor gaming data to determine gaming context characteristics. Gaming context characteristics may, for example, include a user profile of a user of the information handling system executing the gaming application or a game state of the gaming application.

At block 704, the information handling system may determine one or more haptic effects for generation by a linear magnetic ram module of an input device connected to the information handling system based on the one or more gaming context characteristics. If the information handling system is executing the gaming application, the input device may be connected to the information handling system to provide input for controlling the gaming application and to receive instructions from the information handling system such as haptic feedback instructions. If the information handling system is an external information handling system, such as a cloud-based information handling system executing a service for gaming context characteristic and haptic feedback determination, the input device may be connected to the information handling system through the information handling system executing the gaming application. The input device may, for example, be a handheld controller including a linear magnetic ram module. The linear magnetic ram module may include one or more linear magnetic rams for generating haptic feedback. Determining the one or more haptic effects may include determining one or more active effects, such as one or more tachammer mode chassis impacts, or one or more haptic patterns, such as one or more frequencies at which one or more linear magnetic rams should be operated. The haptic patterns and/or active effects may be determined, for example, based on one or more gaming context characteristics. In some embodiments, the haptic patterns and/or active effects may be determined based on one or more haptic profiles determined based on gaming context characteristics. The one or more haptic effects may be determined based on the one or more active effects and the one or more haptic patterns. In some embodiments, the one or more haptic effects may include at least one of a haptic output effect, such as a tachammer mode chassis impact, a haptic output rate, such as a frequency of operation of one or more linear magnetic rams of the linear magnetic ram module, or a haptic output intensity, such as a velocity or power at which a linear magnetic ram is operated. In some embodiments, the one or more haptic effects may include a haptic output effect pattern, a frequency pattern, or a haptic output intensity pattern at which a linear magnetic ram is operated. For example, a varying frequency and/or intensity of operation of a linear magnetic ram over time may be determined. Alternatively or additionally, the one or more haptic effects may include a raw waveform effect, such as a raw waveform effect determined on in-game or external audio. Alternatively or additionally, the one or more haptic effects may include a harmonic haptic effect for a plurality of motors of the linear magnetic ram module. For example, a frequency at which a plurality of linear magnetic rams of a linear magnetic ram module will be operated to produce a harmonic haptic effect may be determined. Alternatively or additionally, the one or more haptic effects may include an adjustment to a tunable damping medium of the linear magnetic ram module. Thus, a variety of wide-band haptic effects may be determined based on gaming context characteristics. As discussed herein, such a determination may be made by an information handling system executing a gaming application or by another information handling system, such as an information handling system executing a cloud-based service for gaming context characteristic and haptic feedback generation.

At block 706, the information handling system may transmit one or more instructions to a handheld controller to generate the determined haptic effects. For example, an information handling system executing the gaming application may transmit instructions to an input device, such as a handheld controller, to generate the one or more haptic effects using the linear magnetic ram module. As another example, a cloud-based information handling system, such as a cloud-based server executing a service for gaming context characteristic and haptic feedback determination, may transmit one or more instructions to generate the determined haptic effects to an input device by way of an information handling system executing the gaming application for which haptic feedback is generated. Thus, wide-band haptic feedback may be generated for a user based on gaming context characteristics using a linear magnetic ram module of an input device. Such haptic feedback may be generated even when gaming applications are not programmed to provide such feedback, as gaming context characteristics may be determined by a background service executed by an information handling system or in the cloud and may be used as a basis for determining one or more haptic effects to be generated by an input device.

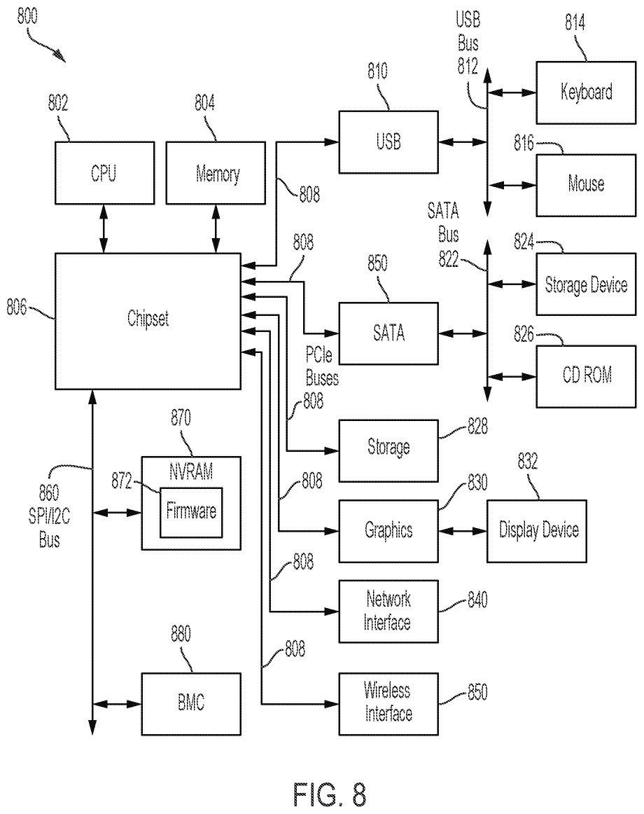

FIG. 8 illustrates an example information handling system 800. Information handling system 800 may include a processor 802 (e.g., a central processing unit (CPU)), a memory (e.g., a dynamic random-access memory (DRAM)) 804, and a chipset 806. In some embodiments, one or more of the processor 802, the memory 804, and the chipset 806 may be included on a motherboard (also referred to as a mainboard), which is a printed circuit board (PCB) with embedded conductors organized as transmission lines between the processor 802, the memory 804, the chipset 806, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 802, the memory 804, the chipset 806, and/or other components may be organized as a System on Chip (SoC).

The processor 802 may execute program code by accessing instructions loaded into memory 804 from a storage device, executing the instructions to operate on data also loaded into memory 804 from a storage device, and generate output data that is stored back into memory 804 or sent to another component. The processor 802 may include processing cores capable of implementing any of a variety of instruction set architectures (ISAs), such as the x86, POWERPC®, ARM®, SPARC®, or MIPS@ ISAs, or any other suitable ISA. In multi-processor systems, each of the processors 802 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 806 may facilitate the transfer of data between the processor 802, the memory 804, and other components. In some embodiments, chipset 806 may include two or more integrated circuits (ICs), such as a northbridge controller coupled to the processor 802, the memory 804, and a southbridge controller, with the southbridge controller coupled to the other components such as USB 810, SATA 820, and PCIe buses 808. The chipset 806 may couple to other components through one or more PCIe buses 808.

Some components may be coupled to one bus line of the PCIe buses 808, whereas some components may be coupled to more than one bus line of the PCIe buses 808. One example component is a universal serial bus (USB) controller 810, which interfaces the chipset 806 to a USB bus 812. A USB bus 812 may couple input/output components such as a keyboard 814 and a mouse 816, but also other components such as USB flash drives, or another information handling system. Another example component is a SATA bus controller 820, which couples the chipset 806 to a SATA bus 822. The SATA bus 822 may facilitate efficient transfer of data between the chipset 806 and components coupled to the chipset 806 and a storage device 824 (e.g., a hard disk drive (HDD) or solid-state disk drive (SDD)) and/or a compact disc read-only memory (CD-ROM) 826. The PCIe bus 808 may also couple the chipset 806 directly to a storage device 828 (e.g., a solid-state disk drive (SDD)). A further example of an example component is a graphics device 830 (e.g., a graphics processing unit (GPU)) for generating output to a display device 832, a network interface controller (NIC) 840, and/or a wireless interface 850 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces).

The chipset 806 may also be coupled to a serial peripheral interface (SPI) and/or Inter-Integrated Circuit (I2C) bus 860, which couples the chipset 806 to system management components. For example, a non-volatile random-access memory (NVRAM) 870 for storing firmware 872 may be coupled to the bus 860. As another example, a controller, such as a baseboard management controller (BMC) 880, may be coupled to the chipset 806 through the bus 860. BMC 880 may be referred to as a service processor or embedded controller (EC). Capabilities and functions provided by BMC 880 may vary considerably based on the type of information handling system. For example, the term baseboard management system may be used to describe an embedded processor included at a server, while an embedded controller may be found in a consumer-level device. As disclosed herein, BMC 880 represents a processing device different from processor 802, which provides various management functions for information handling system 800. For example, an embedded controller may be responsible for power management, cooling management, and the like. An embedded controller included at a data storage system may be referred to as a storage enclosure processor or a chassis processor.

System 800 may include additional processors that are configured to provide localized or specific control functions, such as a battery management controller. Bus 860 can include one or more busses, including a Serial Peripheral Interface (SPI) bus, an Inter-Integrated Circuit (I2C) bus, a system management bus (SMBUS), a power management bus (PMBUS), or the like. BMC 880 may be configured to provide out-of-band access to devices at information handling system 800. Out-of-band access in the context of the bus 860 may refer to operations performed prior to execution of firmware 872 by processor 802 to initialize operation of system 800.

Firmware 872 may include instructions executable by processor 802 to initialize and test the hardware components of system 800. For example, the instructions may cause the processor 802 to execute a power-on self-test (POST). The instructions may further cause the processor 802 to load a boot loader or an operating system (OS) from a mass storage device. Firmware 872 additionally may provide an abstraction layer for the hardware, such as a consistent way for application programs and operating systems to interact with the keyboard, display, and other input/output devices. When power is first applied to information handling system 800, the system may begin a sequence of initialization procedures, such as a boot procedure or a secure boot procedure. During the initialization sequence, also referred to as a boot sequence, components of system 800 may be configured and enabled for operation and device drivers may be installed. Device drivers may provide an interface through which other components of the system 800 can communicate with a corresponding device. The firmware 872 may include a basic input-output system (BIOS) and/or include a unified extensible firmware interface (UEFI). Firmware 872 may also include one or more firmware modules of the information handling system. Additionally, configuration settings for the firmware 872 and firmware of the information handling system 800 may be stored in the NVRAM 870. NVRAM 870 may, for example, be a non-volatile firmware memory of the information handling system 800 and may store a firmware memory map namespace 800 of the information handling system. NVRAM 870 may further store one or more container-specific firmware memory map namespaces for one or more containers concurrently executed by the information handling system.

Information handling system 800 may include additional components and additional busses, not shown for clarity. For example, system 800 may include multiple processor cores (either within processor 802 or separately coupled to the chipset 806 or through the PCIe buses 808), audio devices (such as may be coupled to the chipset 806 through one of the PCIe busses 808), or the like. While a particular arrangement of bus technologies and interconnections is illustrated for the purpose of example, one of skill will appreciate that the techniques disclosed herein are applicable to other system architectures. System 800 may include multiple processors and/or redundant bus controllers. In some embodiments, one or more components may be integrated together in an integrated circuit (IC), which is circuitry built on a common substrate. For example, portions of chipset 806 can be integrated within processor 802. Additional components of information handling system 800 may include one or more storage devices that may store machine-executable code, one or more communications ports for communicating with external devices, and various input and output (I/O) devices, such as a keyboard, a mouse, and a video display.

In some embodiments, processor 802 may include multiple processors, such as multiple processing cores for parallel processing by the information handling system 800. For example, the information handling system 800 may include a server comprising multiple processors for parallel processing. In some embodiments, the information handling system 800 may support virtual machine (VM) operation, with multiple virtualized instances of one or more operating systems executed in parallel by the information handling system 800. For example, resources, such as processors or processing cores of the information handling system may be assigned to multiple containerized instances of one or more operating systems of the information handling system 800 executed in parallel. A container may, for example, be a virtual machine executed by the information handling system 800 for execution of an instance of an operating system by the information handling system 800. Thus, for example, multiple users may remotely connect to the information handling system 800, such as in a cloud computing configuration, to utilize resources of the information handling system 800, such as memory, processors, and other hardware, firmware, and software capabilities of the information handling system 800. Parallel execution of multiple containers by the information handling system 800 may allow the information handling system 800 to execute tasks for multiple users in parallel secure virtual environments.

The schematic or flow chart diagram FIG. 7 is generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Machine learning models, as described herein, may include logistic regression techniques, linear discriminant analysis, linear regression analysis, artificial neural networks, machine learning classifier algorithms, or classification/regression trees in some embodiments. In various other embodiments, machine learning systems may employ Naive Bayes predictive modeling analysis of several varieties, learning vector quantization artificial neural network algorithms, or implementation of boosting algorithms such as Adaboost or stochastic gradient boosting systems for iteratively updating weighting to train a machine learning classifier to determine a relationship between an influencing attribute, such as received device data, and a system, such as an environment or particular user, and/or a degree to which such an influencing attribute affects the outcome of such a system or determination of environment.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although processors are described throughout the detailed description, aspects of the invention may be applied to the design of or implemented on different kinds of processors, such as graphics processing units (GPUs), central processing units (CPUs), and digital signal processors (DSPs). As another example, although processing of certain kinds of data may be described in example embodiments, other kinds or types of data may be processed through the methods and devices described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
determining, by an information handling system, one or more gaming context characteristics of a gaming application;
determining, by the information handling system, one or more haptic effects for generation by a linear magnetic ram module of an input device connected to the information handling system based on the one or more gaming context characteristics; and
transmitting, by the information handling system to the input device, one or more instructions to generate the determined one or more haptic effects.

2. The method of claim 1, wherein the one or more gaming context characteristics comprise at least one of:
a user profile of a user of the information handling system; or
a game state of the gaming application.

3. The method of claim 1, wherein determining the one or more haptic effects comprises:
determining one or more active effects;
determining one or more haptic patterns; and
determining the one or more haptic effects based on the one or more active effects and the one or more haptic patterns.

4. The method of claim 1, wherein the one or more haptic effects comprise at least one of:
a haptic output effect;
a haptic output rate; or
a haptic output intensity.

5. The method of claim 1, wherein the one or more haptic effects comprise a raw waveform effect.

6. The method of claim 1, wherein the one or more haptic effects comprise a harmonic haptic effect for a plurality of motors of the linear magnetic ram module.

7. The method of claim 1, wherein the one or more haptic effects comprise an adjustment to a tunable damping medium of the linear magnetic ram module.

8. An information handling system, comprising:
a memory; and
at least one processor coupled to the memory, wherein the at least one processor is configured to:
determine one or more gaming context characteristics of a gaming application executed by the information handling system;
determine one or more haptic effects for generation by a linear magnetic ram module of an input device connected to the information handling system based on the one or more gaming context characteristics; and
transmit, to the input device, one or more instructions to generate the determined one or more haptic effects.

9. The information handling system of claim 8, wherein the one or more gaming context characteristics comprise at least one of:
a user profile of a user of the information handling system; or
a game state of the gaming application.

10. The information handling system of claim 8, wherein to determine the one or more haptic effects the at least one processor is further configured to:
determine one or more active effects;
determine one or more haptic patterns; and
determine the one or more haptic effects based on the one or more active effects and the one or more haptic patterns.

11. The information handling system of claim 8, wherein the one or more haptic effects comprise at least one of:
a haptic output effect;
a haptic output rate; or
a haptic output intensity.

12. The information handling system of claim 8, wherein the one or more haptic effects comprise a raw waveform effect.

13. The information handling system of claim 8, wherein the one or more haptic effects comprise a harmonic haptic effect for a plurality of motors of the linear magnetic ram module.

14. The information handling system of claim 8, wherein the one or more haptic effects comprise an adjustment to a tunable damping medium of the linear magnetic ram module.

15. A computer program product, comprising:
a non-transitory computer readable medium comprising instructions for causing an information handling system to perform steps comprising:
determining one or more gaming context characteristics of a gaming application;
determining one or more haptic effects for generation by a linear magnetic ram module of an input device connected to the information handling system based on the one or more gaming context characteristics; and
transmitting, to the input device, one or more instructions to generate the determined one or more haptic effects.

16. The computer program product of claim 15, wherein determining the one or more haptic effects comprises:
determining one or more active effects;
determining one or more haptic patterns; and
determining the one or more haptic effects based on the one or more active effects and the one or more haptic patterns.

17. The computer program product of claim 15, wherein the one or more haptic effects comprise at least one of:
a haptic output effect;
a haptic output rate; or
a haptic output intensity.

18. The computer program product of claim 15, wherein the one or more haptic effects comprise a raw waveform effect.

19. The computer program product of claim 15, wherein the one or more haptic effects comprise a harmonic haptic effect for a plurality of motors of the linear magnetic ram module.

20. The computer program product of claim 15, wherein the one or more haptic effects comprise an adjustment to a tunable damping medium of the linear magnetic ram module.
